(19) United States
(12) Patent Application Publication
(10) Pub. No.: US 2011/0151922 A1
(43) Pub. Date: Jun. 23, 2011

(54) METHOD AND SYSTEM FOR CONDUCTING WIRELESS COMMUNICATIONS

(76) Inventor: Chris Venteicher, Williams Bay, WI (US)

(21) Appl. No.: 12/642,600

(22) Filed: Dec. 18, 2009

(51) Int. Cl. H04M 1/00

(52) U.S. Cl. 455/550.1

(57) ABSTRACT

The present invention relates to method and systems for conducting wireless communications. In one embodiment, the present invention relates to a method for conducting communications using a mobile device. The method includes configuring a mobile device having a mobile operating system to communicate with a computer, and operating the mobile device so that the mobile device enters into communication with at least one of a cellular-based network and a non-cellular-based network. The method also includes receiving communication signals at the mobile device, arriving from the at least one of a cellular-based network and a non-cellular-based network, and monitoring the received communication signals for updated data from a content provider website during a period when the computer is in a reduced function mode. The method additionally includes sending a wake-up command for receipt by the computer when the updated data is detected.

### FIELD OF THE INVENTION

The present invention relates to wireless communications and, more particularly, to wireless communications involving portable computers and/or other mobile devices that may face constraints relating to power availability.

### BACKGROUND OF THE INVENTION

Portable computers, such as laptops, have long suffered from limitations associated with the use of batteries, which have an undesirably short life. In an effort to provide longer battery life, manufactures have incorporated various power saving modes, such as a sleep mode and hibernation mode. These modes enable the computer to enter a low power state when computer usage diminishes to set level for a set period of time. By setting the computer to a low power state, the computer uses significantly less power, thereby extending battery life. While in a low power state, one or more computer hardware devices (Such as hard-drives, video display, and network cards, etc.) are powered down. As a result, software applications that utilize these devices also cease to run. These devices will remain in the low power state until the computer is “awakened,” typically when a user pushes a button on the computer or another triggering event occurs. As a result of the hardware and software shutdowns, devices such as the wireless network card and software such as web-browsers are no longer able to communicate with the internet or other networks.

Typically, a computer user will run applications such as a web-browser to facilitate communications with other users via the internet. The user will send and receive correspondence from the various other users by connecting to one or more of several content provider websites (CPWs) that can facilitate communications between users, such as email, instant messaging (IM), and blogging. Some examples of the aforementioned CPWs can include Gmail, Yahoo Mail, and AOL, as well as various social networking websites (SNWs), such as Twitter, MySpace, Facebook, and LinkedIn. For a user to check if any updated information is available for an application (e.g. Twitter, Gmail, etc), the user needs to manually awaken the computer, thereby allowing an application to resume operation. For example, the user will operate a mouse button, keyboard button, or power switch to awaken the computer. Once awakened, the application can reconnect to the internet and be refreshed to check for any updated data.

The demand for computers to maintain a full power state has increased at least in part due to the increasing popularity of SNWs that foster the desire for immediate transmission and reception of correspondence. Commonly, a transmitting user will send an initial communication and wait for a response from a receiving user. The time frame for receiving a response can vary greatly, depending on the application network used and/or the receiver(s) of the communication. When a user is in very active communications with an expected rapid response time, the computer is typically operated in a high power state so that the user can instantly receive a responsive communication. Although, when a communication is not particularly active, having an expected long response time, the user may wish to let their computer switch to a low power state to conserve battery life. Further, the user is not made aware that a new communication has been sent until they awaken their computer and wait for it to reconnect with the internet and update the application data. The common desire to maintain instant communications and/or receive updated correspondence as soon as possible, can limit a user's ability to enjoy extended battery life from their portable computer, resulting in less overall use of the computer before requiring the battery to be recharged. Users are therefore choosing between being connected to the internet continuously, by maintaining a high power state, to immediately receive updated correspondence, and entering a low power state to conserve battery power for later connections.

Maintaining a high power state also can be important for other reasons as well. Among other things, computer users will often desire to be fully mobile, which in turn can occasionally create a need to disconnect from a given wireless local area network (WLAN) connection or move outside the range of a given wireless network. Such actions can result in a loss of internet communications, at least until the user's computer enters the range of another wireless network or reconnects to another WLAN. Although various cellular-based wireless devices are available to allow a computer to connect to the internet over a cellular network, these devices operate using an AT command interface, similar to a modem. As such, these current devices are very limited in functionality and they require the computer operating system to be operating outside of sleep or hibernation mode to function, that is, in a full power state mode of operation. When a computer is rebooted or fails entirely, any connection to a web application through such device is terminated.

It would therefore be advantageous if improvements, in the form of improved mobile devices and/or other devices, and/or improved methods of operating such devices, can be developed that allow for laptop computers and/or other devices that may face constraints relating to power availability to maintain wireless communications in a manner that better satisfies user demands relating to continuous (or more continuous) connectivity and/or device mobility.

### SUMMARY OF THE INVENTION

In at least one embodiment, the present invention relates to a method of conducting communications using a mobile device. The method includes configuring a mobile device having a mobile operating system to communicate with a computer, and operating the mobile device so that the mobile device enters into communication with at least one of a cellular-based network and a non-cellular-based network. The method also includes receiving communication signals at the mobile device, arriving from the at least one of a cellular-based network and a non-cellular-based network, and monitoring the received communication signals for updated data from a content provider website during a period when the computer is in a reduced function mode. The method additionally includes sending a wake-up command for receipt by the computer when the updated data is detected.

In at least one additional embodiment, the present invention relates to a method of maintaining communication between a content provider website and a computer by way of an intermediate mobile device. The method includes obtaining first information from the content provider website, via a cellular-based communications network, at the mobile device. The method further includes processing the first information at the mobile device so as to provide processed first information, where the processed first information is indicative of a difference between the first information and earlier information previously received from the website, and determining whether the processed first information is of a high importance level. The method additionally includes transmitting the processed first information from the mobile device for receipt by the computer upon determining that the at least some of the processed first information is of the high importance level.

Further, in at least one additional embodiment, the present invention relates to a mobile device. The mobile device includes a wireless transceiver capable of conducting communications with a cellular-based network, at least one memory device, and at least one processing device coupled at least indirectly to the wireless transceiver and to the at least one memory device. The mobile device also includes means for conducting communications between the mobile device and a computer device, the means for conducting communications also being coupled at least indirectly to the at least one processing device. The mobile device further includes a mobile operating system and a plurality of applications resident thereon. Further, the mobile device, upon receiving information from the cellular-based network originating from at least one content provider website, determines whether the information is high-importance information and, if so, sends the information for receipt by the computer device.

### BRIEF DESCRIPTION OF THE DRAWINGS

FIG. 1 is a block diagram showing an exemplary communications system involving a mobile device in communication with a computer and the internet;

FIG. 2 is a block diagram showing exemplary components of the mobile device of FIG. 1;

FIG. 3 shows, in schematic form, portions of FIG. 1 in greater detail, where some of the communications can occur via an intermediary web server; and

FIG. 4 is a flow chart showing various exemplary steps of operation of the communication system of FIG. 1.

### DETAILED DESCRIPTION OF THE INVENTION

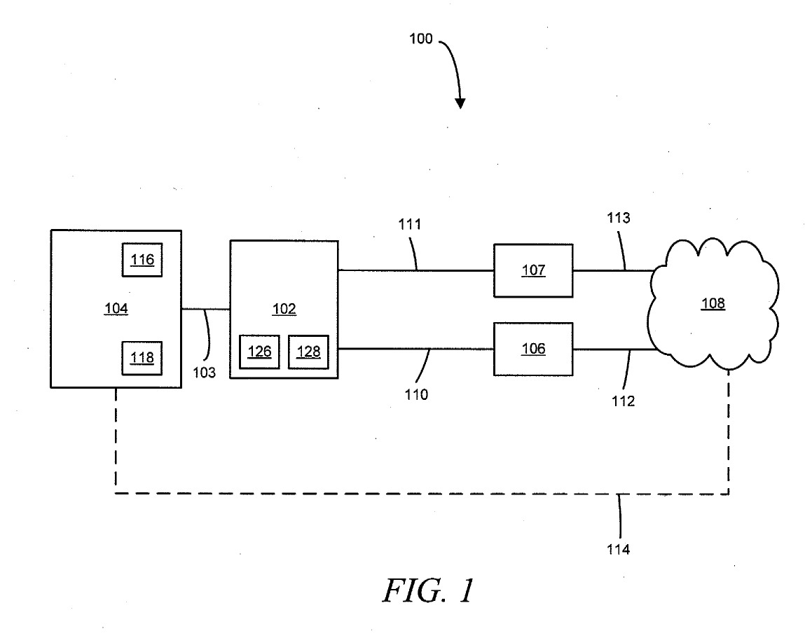

Referring to FIG. 1, an exemplary communications system 100 involving a mobile device 102 in communication with the internet is shown, in accordance with at least some embodiments of the present invention. As shown, the communication system 100 includes the mobile device 102 that is coupled, via a communication link or pathway 103, with a computer 104. In the present embodiment, the computer 104 is a portable computer (e.g., a laptop computer or notebook computer), and the mobile device 102 is a wireless cellular device such as a cellular telephone, personal digital assistant (PDA), smart phone, data card, or any of a variety of other cellular-based mobile devices. As will be discussed further below, in at least one embodiment, the mobile device 102 is a wireless communications data card that can be removably plugged into the computer 104 and can communicate with a network using a cellular connection and/or a wireless land area network (WLAN).

The communication pathway 103 by which the computer 104 is in communication with the mobile device 102 can be a wired connection achieved by way of a cable (or simply by virtue of the mobile device 102 being plugged into the computer 104). Alternatively, the communication pathway 103 can be a type of wireless communications, such as Bluetooth. In addition to being in communication with the computer 104, the mobile device 102 is also capable of communicating with a network, such as cellular network 106 (which includes, for example, a cellular tower), and/or a WLAN network 107 (or Wi-Fi). Communications over the cellular network 106 occur via a wireless communication link or pathway 110 and, by virtue of such communications with the cellular network, further capable of communicating with the internet 108 via an additional communication link or pathway 112 shown to exist between the cellular network and the internet 108. Similarly, the mobile device 102 can communicate with the internet over the WLAN network 107 via communication links 111 and 113.

It will be understood that, by virtue of being in communication with the internet 108 via the pathways 110, 112, 111, 113 the mobile device 102 is further capable of being in communication with the “World Wide Web” and with numerous websites forming a part thereof, including a variety of content provider websites (CPWs) including social networking websites (SNWs) and other web applications (for example, Twitter, MySpace, Facebook, other SNWs, various email services, blogs and message boards, etc.). Additionally as shown, although not necessarily the case, in some embodiments the computer 104 can also communicate with the internet 108 independently of the mobile device 102 using a non-cellular-based system network 114. The non-cellular-based system network 114 can take any of a variety of forms, such as a local area network (LAN) and a wireless local area network (WLAN).

The computer 104 should be understood as encompassing conventional computer components, for example, one or more processing devices such as microprocessors, one or more storage devices (e.g., read-only memory (ROM) devices, random access memory (RAM) devices, static random access memory (SRAM) devices, and/or dynamic random access memory (DRAM) devices), one or more input devices such as a keyboard and/or a mouse, and one or more output devices such as a video display, etc. In addition, in at least some embodiments, the computer 104 can take other forms including, for example, other processor-based graphical user interface devices such as desktop computers, set-top boxes, and video games. Further as shown, the computer 104 includes a standard operating system 116, such as Linux, Microsoft Windows, Snow Leopard, etc., as well as includes one or more applications 118, such as a web-browser (e.g. Internet Explorer, Mozilla, etc.), which are supported by the operating system. The operating system 116 and applications 118 can be stored on the storage device(s) of the computer 104 and run on the processing device(s) of the computer.

In the present embodiment, the mobile device 102 facilitates communications between the computer 104 and the cellular network 106 and thus the internet 108, and serves as a proxy for the computer 104 itself in terms of communicating with the cellular network 106/internet 108. The mobile device 102 in the present embodiment communicates with the cellular network 106 via the pathway 110 in accordance with one or more data/voice standards, such as the third-generation (3G) and fourth generation (4G) standards. Further, the mobile device 102 includes one or more mobile operating systems (or application frameworks) 126, for example, Android, Linux, Iphone, or Windows Mobile, thereby allowing the mobile device 102 to communicate and interact with the internet 108 independently of any of the operating system(s) 116 running on the computer 104. In addition, each of the mobile operating systems 126 can be used to run one or more of numerous software applications 128 (which can be web-based and/or non-web-based applications, including possibly applications available for a fee-based download).

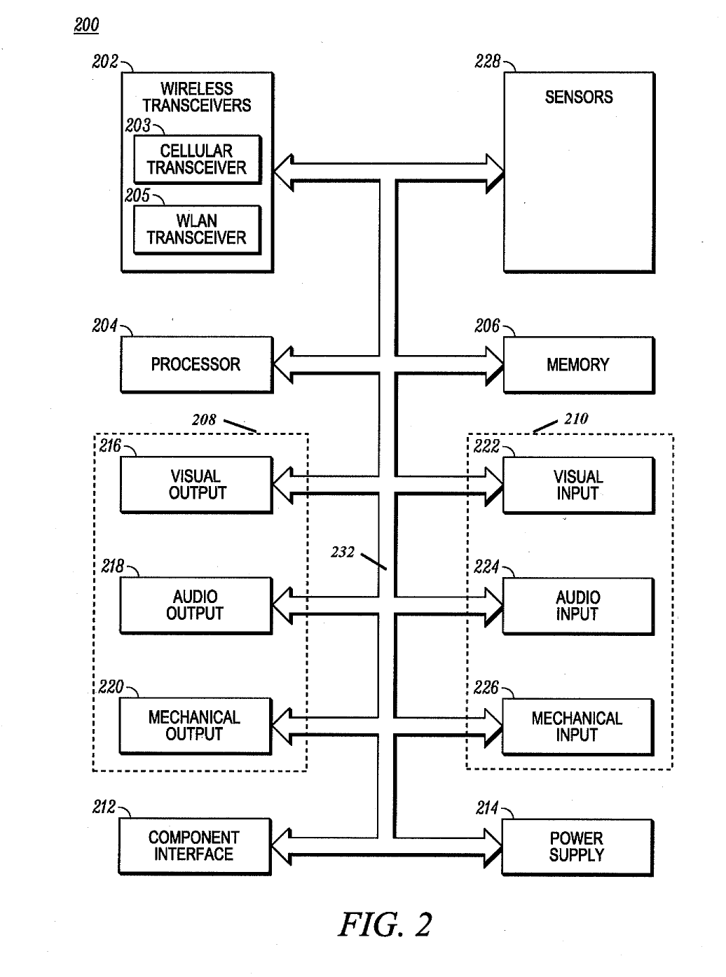

Referring now to FIG. 2, a block diagram is provided illustrating example internal components 200 of the mobile device 102. As shown in FIG. 2, the components 200 include one or more wireless transceivers 202, a processor 204 (e.g., a microprocessor, microcomputer, application-specific integrated circuit, etc.), a memory portion 206, one or more output devices 208, and one or more input devices 210. In at least some embodiments, a user interface is present that comprises one or more of the output devices 208, such as a display, and one or more of the input device 210, such as a keypad or touch sensor. The internal components 200 can further include a component interface 212 to provide a direct connection to auxiliary components or accessories for additional or enhanced functionality. In the present embodiment, the component interface 212 can also be understood as a port by which the mobile device is directly coupled (e.g., by way of a cable or connector/plug) to the computer 104. The internal components 200 can also include a power supply 214, such as a battery, for providing power to the other internal components while enabling the device to be portable. All of the internal components 200 can be coupled to one another, and in communication with one another, by way of one or more internal communication links 232 (e.g., an internal bus).

Each of the wireless transceivers 202 utilizes a wireless technology for communication, which can include for example (but are not limited to) cellular-based communication technologies such as analog communications (using AMPS), digital communications (using CDMA, TDMA, GSM, iDEN, 3G, GPRS, EDGE, etc.), and next generation communications (using UMTS, WCDMA, 4G, LTE, IEEE 802.16, etc.) or variants thereof, or peer-to-peer or ad hoc communication technologies such as HomeRF (radio frequency), Bluetooth, wireless local area network (WLAN) protocols such as IEEE 802.11 (a, b, g or n), or other wireless communication technologies such as infrared technology. In the present embodiment, the wireless transceivers 202 include a cellular transceiver 203 (e.g. WWAN transceiver) and a WLAN transceiver 205, although in other embodiments only one of these types of wireless transceivers and/or other types of wireless transceiver(s) can be present. In some embodiments, the wireless transceivers 202 allow for communication only with the cellular network 106 (e.g., where the pathway 103 is a wired connection) while, in other embodiments, the wireless transceiver 202 allow for communication with both the cellular network 106 and the computer 104 (e.g., by way of a Bluetooth connection).

Example operation of the wireless transceivers 202 in conjunction with others of the internal components 200 of the mobile device 102 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceivers 202 convey the modulated signals by way of wireless communication links (corresponding to the communication pathway 110) to the cellular network 106, which in turn conveys communications to the internet 108.

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 among other things can include a video screen. Likewise, by example, the input device(s) 210 can include one or more visual input devices 222 such as an optical sensor (for example, a camera), one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the device, unlocking the device, moving the device to actuate a motion, moving the device to actuate a location positioning system, and operating the device.

As shown in FIG. 2, the internal components 200 of the mobile device 102 also can include one or more of various types of sensors 228. The sensors 228 can include, for example, proximity sensors (e.g., a light detecting sensor, an ultrasound transceiver or an infrared transceiver), touch sensors, altitude sensors, and/or a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 102.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. It will be understood that the data that is stored by the memory portion 206 can include, but need not be limited to, instructions/code governing operation of the operating systems 126, and applications 128, as well as informational data. Each operating system 206 in particular can include executable code that controls basic functions of the mobile device, such as interaction among the various components included among the internal components 200, communication with external devices via the wireless transceivers 202 and/or the component interface 212, and storage and retrieval of applications and data, to and from the memory portion 206. In the present embodiment, the processor 204 is configured to run the one or more operating systems 126.

As for the applications 128, each application includes executable code that utilizes one or more of the operating systems 126 to provide more specific functionality for the mobile device, such as file system service and handling of protected and unprotected data stored in the memory portion 206. In the present embodiment, the operating systems 126 are configured to run a plurality of the applications 128, such as a web browser, etc. that allow for interaction between the mobile device and one or more websites available via the internet 108 including, for example, social networking websites. As for informational data, that is non-executable code or information that can be referenced and/or manipulated by an operating system or application for performing functions of the communication device.

It should being understood that FIG. 2 is particularly representative of the components found in the mobile device 102 when it takes the form of a standalone device such as a cellular telephone, PDA, smartphone, etc. By comparison, in embodiments where the mobile device is merely a wireless communications data card, only a subset of the components shown in FIG. 2 will typically be present. For example, a user interface, input devices, and/or output devices need not be present embodiments where the mobile device is merely a wireless communications data card.

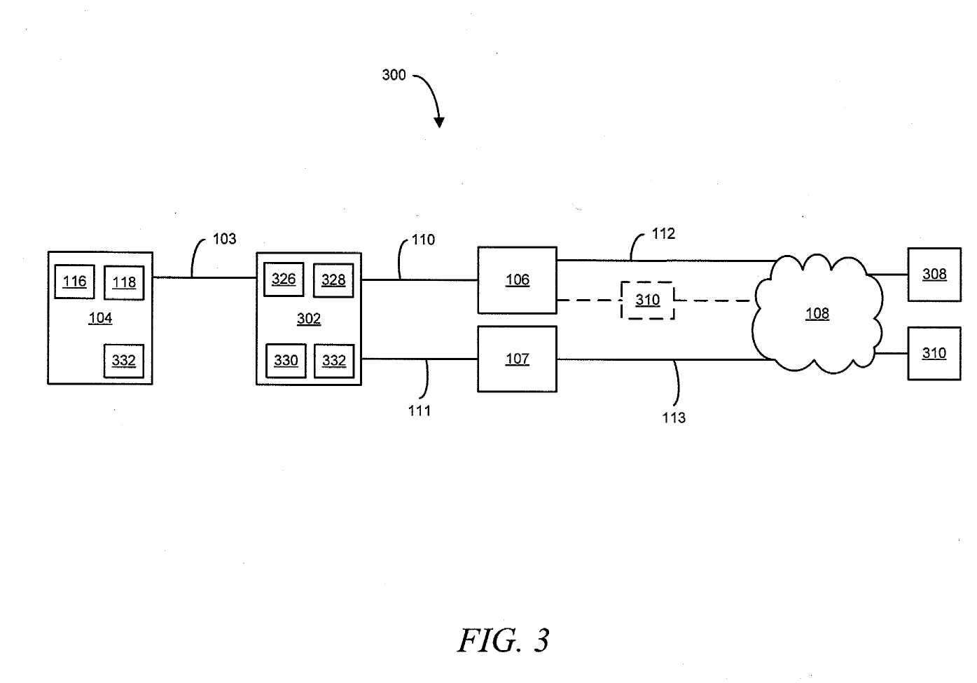

Turning now to FIG. 3, one particular exemplary embodiment of the system 100 of FIG. 1, namely, a system 300, is shown in more detail. In the system 300, the computer 104 is in direct communication, via the communication pathway 103, with one of the mobile devices 102 that in this example is a data card 302. The data card 302 in turn is in communication with the cellular network 106 via the communication pathway 110, and the cellular network 106 additionally is in communication with the internet 108 via the communication pathway 112. FIG. 3 in particular shows the internet 108 to be in communication with, and thus to be allowing communications of the data card 302 with, one or more SNWs 308 and/or other CPWs 310.

In the present embodiment, the data card 302 is a wireless cellular-based device, such as a Wireless Wide Area Network (WWAN) data card. The data card 302 is physically configured to be installed in an expansion slot of the computer 104, such as an Express card slot, PC card slot, or PCMCIA slot, or otherwise is coupled with the laptop 104 in another manner, such as by way of a Universal Serial Bus (USB) connection. Any of these manners of installation/coupling can be considered represented by the communication pathway 103. The data card 302 of FIG. 3 in particular includes a mobile operating system 326 (which can be considered one of the operating systems 126 of FIG. 1) that is configured to operate independently of the standard operating system(s) 116 in the computer 104 albeit, in alternate embodiments, it is possible that the operating system 326 will operate in conjunction with or in a coordinated manner with the operating system 116. Further, the data card 302 also includes application(s) 328 that are supported by the operating system(s) 326 and can be among the application(s) 128 shown in FIG. 1.

As was the case with respect to FIG. 1, the computer 104 includes, among other things, the operating system(s) 116 and the application(s) 118. In alternate embodiments, the computer 104 can also be pre-configured to include the data card 302 situated inside the computer during manufacturing, in a manner where the data card is physically connected to (e.g., plugged into) the other hardware/internal circuitry of the computer, so as to obviate the need for any manual connection of the data card to the computer, any connector/wire extending outward from the computer allowing for connection of the data card to the computer, or any wireless transceivers or other equipment specifically allowing for wireless communications between the computer and the data card. Although each of FIGS. 1 and 3 shows a single mobile device as being coupled between the computer 104 and the cellular network 106, it should be understood that in additional alternate embodiments more than one mobile device (e.g., both a cellular telephone and a data card) can be simultaneously coupled between the computer 104 and the cellular network 106.

In the systems 100, 300 of each of FIGS. 1 and 3, the applications 128, 328 of the mobile devices 102, 302 can be considered “parallel applications” with respect to the applications 118 of the computer 104 insofar as the applications 128, 328 are able to conduct communications with the internet 108 (and thus with CPWs 308/SNWs 310) in the same manner or in a substantially similar manner as the applications 118 would conduct communications with the internet 108 (and CPWs/SNWs) if those applications 118 were directly in communications with the internet 108 (and CPWs/SNWs), for example, via the network 114 of FIG. 1. The applications 128, 328 can also be considered proxies for the applications 118 insofar as the applications 128, 328 can operate in place of the applications 118 in circumstances when it is not desirable for the applications 118 to maintain full or continuous operation (e.g., when the computer 104 is in a low-power mode). The operation of the mobile devices 102, 302 in some sense can be thus considered to involve the hosting of parallel applications.

In general, the mobile devices 102, 302 and its applications 128, 328 are able to operate independently of the computer 104 and its applications 118 (albeit, in some circumstances, the applications 128, 328 and applications 118 operate with one another in a coordinated manner). Because of this ability to be operated independently, the systems 100, 300 are able to achieve significant versatility of operation. For example, with respect to FIG. 3, the data card 302 can be running one or more of the applications 328 while the computer 104 connected thereto is in a reduced function mode of operation, for example, while the computer is in a low power state (e.g., a sleep mode, hibernation mode, etc.). Although in some embodiments the mobile devices 102, 302 have their own power supplies (e.g., batteries), in other embodiments, the mobile devices 102, 302 access power from the computer 104. In at least some such embodiments, the data card 302 (or other mobile device 102) can access the battery of the computer 104 even when the computer is otherwise in a reduced function mode of operation, for the purpose of obtaining power for itself, such that the data card can avoid a shutdown despite the computer being in the reduced function mode of operation.

As already mentioned, while in a reduced function mode of operation such as a low power (or completely-powered-down) state, the computer 104 will not receive responses or other updated communications. Nevertheless, because the mobile devices 102, 302 utilize their own resident processors 204 (FIG. 2) with their own mobile operating systems 126, 326 and conduct their own network-based communications by way of the communication pathway(s) 110, 111, the mobile devices 102, 302 are able to maintain up-to-date network connections even when the computer 104 is in the reduced function mode of operation. Further, in contrast to the computer 104, which typically employs a series of power intensive components, the mobile device 102 and particularly certain embodiments of the mobile device such as the data card 302 can be configured to operate with very low power consumption. As a result, the data card 302 or other mobile device 102 can remain in an active state for an extended period of time that can greatly exceed the ability of the computer 104 to remain active, either when using power from the computer or when using power from its own power source.

Referring particularly to FIG. 3, in some embodiments, the data card 302 can more particularly include a system service 330, such as an interaction filtering program. The system service 330 can be considered one of the applications 328, although in FIG. 3 the system service is shown separately from the applications 328. In at least some such embodiments, the system service 330 monitors communications between one or more of the applications 328 on the data card 302 and one or more of the SNWs 308 and/or CPWs 310 with which those applications are in contact. The monitoring in particular can involve the detecting of changes that occur at a level above the Internet Protocol (IP) layer activity. For example, the system service 330 can be configured to monitor the operation of one or more of the application(s) 328 that are web applications, and to detect when such one or more application(s) have been updated with new data, such as when a new email has been received or a blog has been updated with a new entry. In some such embodiments, the system service 330 particularly operates by detecting prompts from the applications 328 that are pre-configured to send data update indications whenever appropriate data updates are received by the applications from the SNWs 308/CPWs 310. In other such embodiments, the system service 330 is configured to periodically initiate communications with the applications 328 to inquire if any new data is available.

Further, in some such embodiments, the system service 330 operates in conjunction with the mobile operating system 326 of the data card 302 to awaken the computer 104 when specific conditions are detected, using for example, one or more Advanced Configuration and Power Interface (ACPI) device(s) that can be provided one on or both of the data card 302 and/or the computer 104. For example, the system service 330 in such embodiments can, upon detecting new data updates as discussed above, provide wake-up commands to the computer 104 by way of the communication pathway 103. Depending upon the embodiment, the commands can be sent directly to the operating system 116 of the computer or sent to one or more of the application(s) 118 on the computer. In cases where the application(s) 118 receive such commands, the application(s) can be pre-configured to maintain operation during a low-power state so that the application(s) can detect the commands from the system service 330 of the data card 302 and in response awaken the computer 104 (or at least initiate the actions necessary to awaken the computer). Notwithstanding the above description, in some alternate embodiments, the mobile operating system 326 can be configured to awaken the computer 104 without the aid of the system service 330, by utilizing the mobile operating system 326 and the standard operating system 116 to coordinate data notifications and awakenings.

In at least some embodiments, the system service 330 can be further configured to evaluate if updated data received by the data card 302 from the SNWs 308/CPWs 310 should be classified as of high importance or low importance, based at least in part upon user settings. Such classifications can in turn be used to determine whether and/or when the computer 104 is awakened from a reduced function mode of operation (e.g., from a low-power state) in response to the receiving of the updated data. For example, the system service 330 can be configured to operate such that, when received data updates are determined to be of high importance, the system service immediately initiates the sending of a command to awaken the computer, while data updates of low importance can be ignored or scheduled to trigger a wake-up command only at appropriate times. The appropriate times at which low importance data will trigger wake-up commands can be based upon various considerations. For example, in some embodiments, such appropriate times are merely periodically-occurring times. In other cases, an appropriate time occurs when particular circumstance(s) have arisen. For example, an appropriate time for initiating a wake-up command based on low importance data updates can occur when the mobile device 102 has determined that a certain quantity of low importance data updates have been detected.

In some circumstances the computer 104 can be in communication with the internet 108 via a non-cellular-based wireless network such as the system network 114 of FIG. 1 (which can be, for example, a WLAN). Yet, particularly when the computer 104 is a portable computer, a user of the computer can often find that the connection via the network 114 is terminated when the user moves the computer out of range of the network. Such a termination can interrupt the user's ability to send and receive communications and can prove frustrating to the user. Often, such terminations occur without warning or occur in a manner where the user only received a delayed warning (e.g., a warning after the fact), and after such terminations occur the user must then re-enter the range of the network 114 to continue communications.

Notwithstanding these difficulties that can occur with communications via the network 114, such difficulties can be overcome through the use of the mobile device 102/data card 302 that communicate with the internet 108 via the cellular network 106 and the communication pathways 110, 112. In particular, communication via the cellular network 106 and pathways 110, 112 is generally less susceptible to interruption, insofar as the cellular network is generally a larger and more stable network connection than the network 114. Thus, when the computer 104 is in communication with the mobile device 102/data card 302 and the mobile device 102/data card 302 is in communication with internet 108 via the cellular network 106 and the communication pathways 110, 112, the computer is able to maintain a connection to the internet that typically remains robust even when the computer is out of the communication range of the non-cellular-based wireless network 114. Further, by virtue of its connection to the internet 108 via the mobile device 102/data card 302 and the cellular network 106, the computer can be in a low power state when transferring from one of the non-cellular-based wireless networks (such as the network 114) to another (not shown), without interrupting the internet connection.

Additionally with respect to FIG. 3, in at least some embodiments the data card 302 can be configured to provide further functionality that is coordinated with other functionality of the computer 104. More particularly, in such embodiments, both the data card 302 and the computer 104 include a desktop sharing/graphical interface type application (or application framework program) 332, such as the X Window System (X11) or Virtual Network Computing (VNC). By virtue of the desktop sharing/graphical interface type application 332, it is possible to provide accessible inputs and outputs to the data card 302 using computer 104 peripherals, such as the keyboard, mouse, and video display. It should be understood that, although the application 332 on each of the computer 104 and data card 302 is shown in FIG. 3 to be separate from the applications 118, 328 on the computer and data card, respectively, the application 332 can nonetheless be considered as among each of those applications.

By virtue of the interface type application 332, the computer 104 can better establish and/or maintain network access as discussed above. In addition to facilitating the waking of the computer 104, the interface type application allows the computer can be in a high power state and continuously operated without a loss of network communication over a broader range area. Additionally, the interface type application 332 makes it possible to utilize the peripherals of the computer 104 to control the mobile operating system 326 on the data card 302, and also enables the computer 104 to run the mobile applications 328 on the data card 302 alone or simultaneously with applications 118 resident on the computer. Such singular or concurrent operations can allow a user to take advantage of a higher bandwidth from one network connection and/or overall decreased download times when multiple downloads are required. Further, utilizing the data card 302 to maintain an internet connection can allow the computer 104 to transcend rebooting procedures without requiring re-initialization of a web application to the internet.

In at least some embodiments, the addition of the data card 302 can allow for applications and services to be instructed to operate specifically on one of the computer 104 or the data card 302, based on their requirements. For example, applications that function well with less disruption in the communication link with the internet 108 and that have relatively low data throughput (e.g., email, instant messaging (IM), etc.) can be configured to utilize the data card 302 regardless of the power state of the computer 104 (e.g., when the computer 104 is in a low power state or even when the computer 104 is in a high power state). Alternatively, applications that require high throughput communications can be configured to utilize the computer 104 when available. Further, specific portions of an application can be configured to operate on the data card 302 and computer 104. For example, with reference to an email service, the data card 302 can perform the following functions: A) provide only a data connection for the email service; or B) the data connection plus an automatic download and caching of email; or C) the functions identified in A) and B) and also a filter for determining when to awaken the computer 104 and notify a user; or D) the functions identified in A), B) and C) and also a website accessible by the computer 104 to retrieve email; or the functions identified in A) through D) and also access to the website, by the computer 104 via a desktop sharing/graphical interface type application, as discussed above.

Referring again to FIG. 3, in an additional embodiment, the communication system 300 can further include an intermediary server 310, such as a proxy server, which is situated in parallel with the communication pathway 112 between the cellular network 106 and the internet 108, and thus between the data card 302 (or other mobile device 102) and the SNWs 308/CPWs 310. The server 310 can be configured to provide back-up support for the communications that transpire between the data card 302 and the SNWs 308/CPWs 310. In at least some embodiments, the data card 302 can include, among the applications 328 that run in conjunction with the mobile operating system 326, one or more applications that facilitate or enhance the capabilities of the server 310 to provide back-up support.

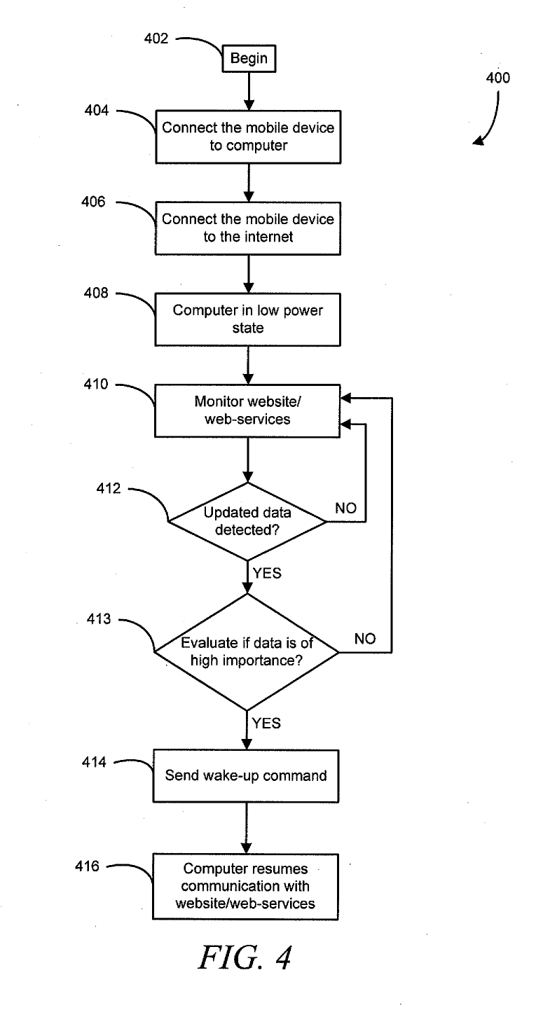

Referring now to FIG. 4, an exemplary method of use for the communication system 100 is described in a flow chart 400. After starting operation at a step 402, at a step 404 the mobile device 102 with the mobile operating system 126 is connected to the computer 104. Next, at a step 406, communications between the mobile device 102 and the internet 108 are initiated by at least one of the mobile device 102 and the computer 104. More particularly, one or more of the applications 128 of the mobile device 102 that are web-based applications, such as a web browser, begin operation to provide a connection to one or more websites or web-services (e.g., the SNWs 308 or CPWs 310 of FIG. 3). Then at a step 408, the computer 104 enters a reduced function mode of operation such as a low power state mode. Notwithstanding this change in the mode of operation of the computer 104, the mobile device 102 remains in communication with the internet 108 (and thus with any particular websites and/or web services).

Further, at a step 410, the websites/web-services that remain in communication with the mobile device 102 are monitored by a system service (such as the system service 330 of FIG. 3), wherein the monitoring can include one or more of actively probing the websites/web-services to detect change(s) in their content and/or receiving change signal(s) initiated from the websites/web-services themselves. If at a step 412 no new data is detected, then the process returns to the step 410 (and cycles back between the steps 410 and 412). However, if at the step 412 the system service 330 detects that the website/web-service data has been updated to include new data (for example, emails, texts, blog entries, instant messages, etc.), then the process moves to a step 413. At the step 413, the data is evaluated to determine if it is of high importance or low importance. If the data is determined to be of low importance, then the process returns to the step 410. Alternatively, if at the step 413 the data is determined to be of high importance, the process advances to a step 414, during which the mobile device 102 then sends a wake-up command to the computer 104. As a result, at a step 416, the computer 104 in turn resumes ongoing communications with the websites/web-services via the mobile device 102 (or possibly another connection such as the network 114).

Notwithstanding the above description provided with respect to FIG. 4, in other embodiments, additional or different operations or steps can be performed by the mobile device 102 other than as discussed. For example, in some other embodiments, when the data is determined to not be of high importance at the step 413, further evaluations are conducted to determine whether the data is of medium or low importance (or of some other importance level). Also for example, in some other embodiments, the mobile device 102 operates to determine whether the data satisfies one or more characteristics in addition to, or instead, of determining the importance level of the data. The flow chart steps of FIG. 4, and/or other steps, can be performed in various manners depending upon the particular type of mobile device 102 is present, and the particular steps can vary depending upon the embodiment (e.g., whether the data card 302 is the mobile device 102 or another device is the mobile device).

It is specifically intended that the present invention not be limited to the embodiments and illustrations contained herein, but include modified forms of those embodiments including portions of the embodiments and combinations of elements of different embodiments as come within the scope of the following claims.

We claim:

1. A method of conducting communications using a mobile device, the method comprising:
configuring a mobile device having a mobile operating system to communicate with a computer;
operating the mobile device so that the mobile device enters into communication with at least one of a cellular-based network and a non-cellular-based network;
receiving communication signals at the mobile device, arriving from the at least one of a cellular-based network and a non-cellular-based network;
monitoring the received communication signals for updated data from a content provider website during a period when the computer is in a reduced function mode; and
sending a wake-up command for receipt by the computer when the updated data is detected.

2. The method of claim 1, wherein communication signals arrive at the mobile device, from a cellular-based network.

3. The method of claim 2, further comprising evaluating the updated data to determine if the updated data is of a high importance or a low importance.

4. The method of claim 3, wherein the sending of the wake-up command occurs substantially immediately when the updated data is determined to be of the high importance, and the sending of the wake-up command occurs only after a delay when the updated data is determined to be of the low importance.

5. The method of claim 2, wherein the updated data from the content provider website is updated data from a social networking website and includes at least one of email information, text information, a blog entry and an instant message.

6. The method of claim 1, wherein the mobile device is a wireless cellular-based network device.

7. The method of claim 6, wherein the wireless cellular-based network device is a data card configured to be removably installed in the computer, and wherein the mobile device is capable of maintaining an internet connection via the cellular-based network independent of an operational status of the computer.

8. The method of claim 7, further comprising:
running a web-browser application on the mobile device by which the mobile device maintains the internet connection, wherein the application is in communication with one or more websites including the content provider website.

9. The method of claim 1, further comprising:
running an application framework program on the mobile device; and
allowing a graphical user interface on the computer to remotely access the mobile device framework, wherein application programs running on the mobile device are controllable by the computer.

10. The method of claim 1, wherein the mobile device operates using power from the computer, and wherein the mobile device continues to receive the communication signals and continues to monitor the received communication signals even while the computer is in the reduced function mode that is a low-power state.

11. A method of maintaining communication between a content provider website and a computer by way of an intermediate mobile device, the method comprising:
obtaining first information from the content provider website, via a cellular-based communications network, at the mobile device;
processing the first information at the mobile device so as to provide processed first information, wherein the processed first information is indicative of a difference between the first information and earlier information previously received from the website;
determining whether the processed first information is of a high importance level; and
transmitting the processed first information from the mobile device for receipt by the computer upon determining that the at least some of the processed first information is of the high importance level.

12. The method of claim 11, wherein the transmitting also includes providing a signal to awaken the computer from a low-power state so as to enable the computer to receive the processed first information, and wherein the transmitting is performed substantially immediately after the determining that the at least some of the processed first information is of the high importance level has occurred.

13. The method of claim 11, further comprising:
additionally determining whether at least one portion of the processed first information is of a low importance level and, upon so determining, then storing the at least one portion of the processed first information for a period of time prior to later transmitting the at least one portion of the processed first information for receipt by the computer.

14. The method of claim 11, further comprising receiving additional communication signals arriving from the cellular-based network at the mobile device, the additional communication signals including update information from the content provider website and at least one additional content provider website that includes a social networking website.

15. The method of claim 11, wherein the mobile device is a wireless communications data card.

16. A mobile device comprising:
a wireless transceiver capable of conducting communications with a cellular-based network;
at least one memory device;
at least one processing device coupled at least indirectly to the wireless transceiver and to the at least one memory device; and
means for conducting communications between the mobile device and a computer device, the means for conducting communications also being coupled at least indirectly to the at least one processing device,
wherein the mobile device further includes a mobile operating system and a plurality of applications resident thereon, and
wherein the mobile device, upon receiving information from the cellular-based network originating from at least one content provider website, determines whether the information is high-importance information and, if so, sends the information for receipt by the computer device.

17. The mobile device of claim 16, wherein the mobile device includes, among the plurality of applications, a system service that operates to detect prompts from others of the applications that are pre-configured to send data update indications whenever appropriate data updates are received by the applications from the at least one content provider website.

18. The mobile device of claim 16, wherein the mobile device includes, among the plurality of applications, a desktop sharing/graphical interface type application or application framework program.

19. The mobile device of claim 16, wherein the mobile device is a data card and wherein the means for conducting communications is selected from the group consisting of a hardwired connection and a Bluetooth transceiver.

20. The mobile device of claim 19, wherein the mobile device is configured to receive power from the computer device, and wherein the mobile device is configured to continue operating and drawing the power from the computer device even during a time period when the computer device is operating in a lower-power mode.
